(19) United States
(12) Patent Application Publication
(10) Pub. No.: US 2011/0250574 A1
(43) Pub. Date: Oct. 13, 2011

(54) PICTURE GRID TOOL AND SYSTEM FOR TEACHING MATH

(76) Inventors: Mickelle Weary, Kirkland, WA (US); Catherine Twomey Fosnot, New London, CT (US); Beth Dudycha, Bothell, WA (US); Laura Koch, Seattle, WA (US); David Fedchenko, Seattle, WA (US); Nigel J. Green, Bellevue, WA (US); Aja M. Hammerly, Seattle, WA (US); Daniel R. Kerns, Mercer Island, WA (US); Rebecca M. Lewis, Tacoma, WA (US); Slavi Marinov Marinov, Varna (BG); Valentin Mihov, Sofia (BG); Petia Radeva, Sofia (BG)

(21) Appl. No.: 13/082,360

(22) Filed: Apr. 7, 2011

Related U.S. Application Data
(60) Provisional application No. 61/321,843, filed on Apr. 7, 2010.

(51) Int. Cl. G09B 7/00

(52) U.S. Cl. 434/188

(57) ABSTRACT

A computer-implemented method for teaching math is disclosed. The method comprises generating a problem for a user to solve; generating a graphical representation of a number associated with the problem; wherein the graphical representation is selected to facilitate subitizing of the number; and overlaying visual guidance on the graphical representation to guide a user as a means to drawing attention to a learning strategy for solving the problem; receiving and checking a user's input as a solution to the problem; and indicating to the user a correctness of the solution.

This application claims the benefit of priority of U.S. 61/321,843, filed Apr. 7, 2010, the entire specification of which is hereby incorporated herein by reference.

### FIELD

Embodiments of the present invention relate generally to software and systems designed for teaching purposes.

### BACKGROUND OF THE INVENTION

Concrete or physical manipulatives such as blocks, math racks, counter, etc., are used to facilitate learning, especially in the field of mathematics. Virtual manipulatives refer to digital “objects” that are the digital or virtual counterpart of concrete manipulatives. Virtual manipulatives may be manipulated, e.g., with a pointing device such as a mouse during learning activities.

### BRIEF DESCRIPTION OF THE DRAWINGS

FIGS. 1 to 3 illustrate aspects of a User Interface generated by the picture grid tool and system of the present invention.

FIG. 4 shows an example of hardware for implementing the picture grid tool and system, in accordance with one embodiment of the invention.

### SUMMARY

Embodiments of the present invention disclose a picture grid tool and a method for teaching math based on the picture grid tool. The picture grid tool may be used to introduce early multiplication. Students are supported by giving them a visual representation of basic multiplication and division problems that can be solved by counting objects displayed with the picture grid tool. By displaying objects in columns and rows students are encouraged to solve problems more efficiently by skip counting vs. counting one by one.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown only in block diagram form in order to avoid obscuring the invention.

Reference in this specification to “one embodiment” or “an embodiment” means that a particular feature, structure, or characteristic described in connection with the embodiment is included in at least one embodiment of the invention. The appearance of the phrases “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not other embodiments.

Embodiments of the present invention disclose a picture grid tool and a method for teaching math based on the picture grid tool. The picture grid tool may be used to introduce early multiplication. Students are supported by giving them a visual representation of basic multiplication and division problems that can be solved by counting objects displayed with the picture grid tool. By displaying objects in columns and rows students are encouraged to solve problems more efficiently by skip counting vs. counting one by one.

Advantageously, in one embodiment the picture grid tool may be rendered as a virtual manipulative on a display screen so that a learner may interact with the virtual manipulative to solve math problems and to learn math problem solving techniques.

The picture grid tool may be integrated in a system for teaching math. The system may be realized, in one embodiment, as a general-purpose computer comprising suitable instructions for implementing the picture grid tool and associated method.

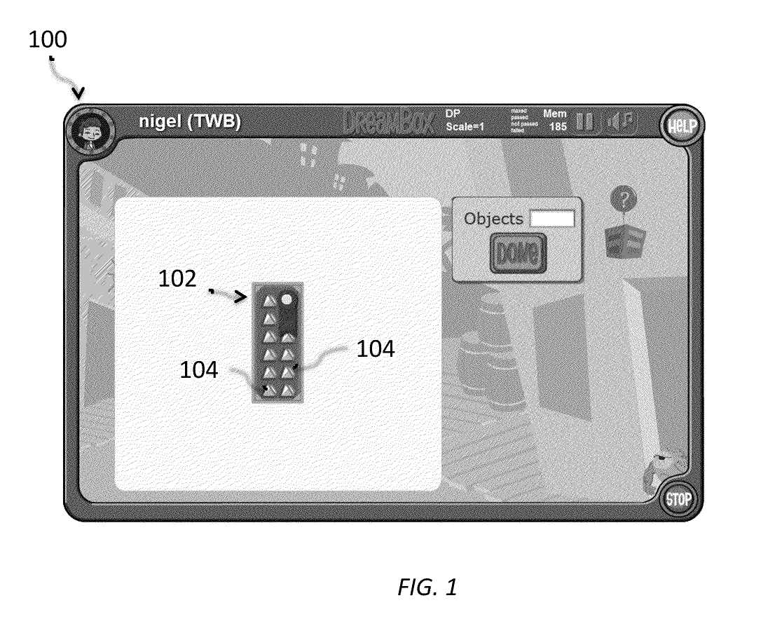

FIG. 1 shows an example of a user interface (UI) 100 generated with the picture grid tool, in accordance with one embodiment of the invention. As will be seen, the UI 100 includes a picture grid 102 that includes a plurality of countable items or tokens 104. The tokens 104 are displayed in an array for ease of counting. Advantageously, the picture grid 102 encourages students to unitize (put items into a group that can be counted more efficiently) and then to use the strategies of repeated addition or skip counting to solve multiplication problems. These strategies help to build automaticity with basic math facts.

In one embodiment, the tokens 104 in the picture grid 102 may be obscured or at least partially obscured. This forces students to move away from counting one to one and encourages them to unitize. In FIG. 1, the two topmost tokens in the right hand column are obscured.

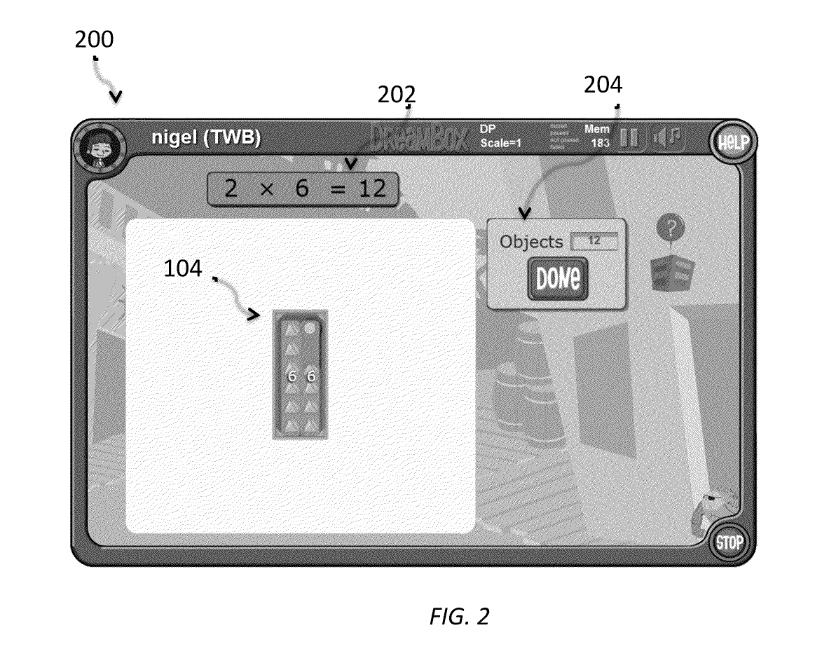

Referring now to FIG. 2, there is shown a UI 200 generated with the picture grid tool in accordance with another embodiment. Parts of the UI in common with the UI 100 have been given the same reference numerals.

The UI 200 includes a problem box 202 for displaying a problem/challenge for a user to solve and a box 204 for inputting a solution to the problem. Advantageously, this embodiment provides chunking or grouping of numbers together. Chunking may be by rows or columns and labels may be given to each chunk. Chunking supports a student's natural tendency to use skip counting and repeated addition. In the example of the UI 200, the two columns represent chunks of “6” and have been labeled accordingly.

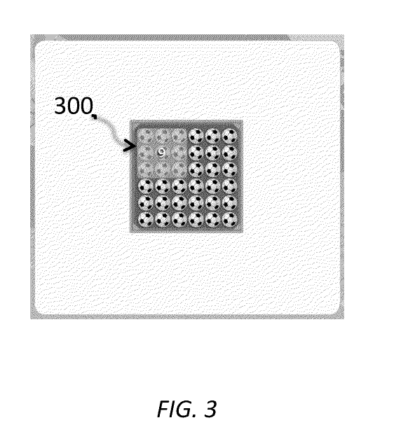

FIG. 3 shows an example of a 6×6 picture grid showing 36 tokens each resembling a soccer ball. Nine tokens forming the upper left hand corner of the grid have been chunked together and are overlaid with a green marker (indicated by reference numeral 300) to designate the chunk visually. This assists a student to arrive at a total count for the grid.

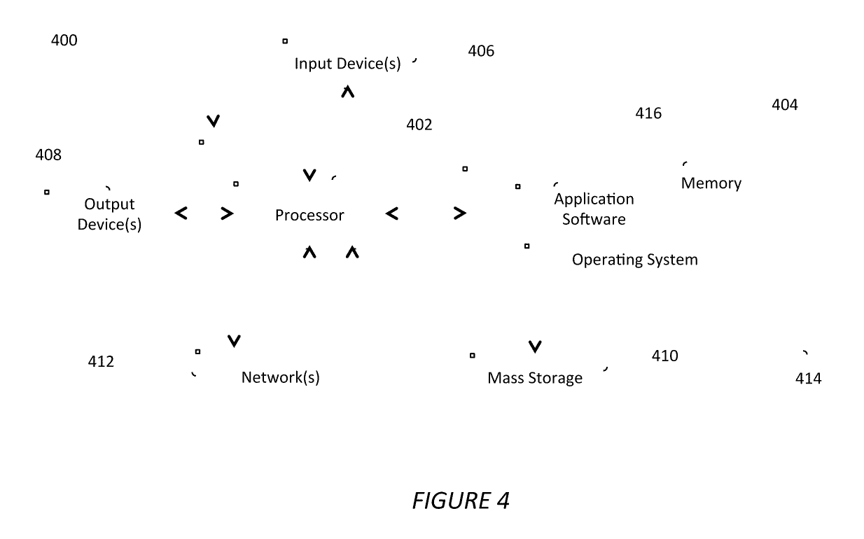

FIG. 4 shows an example of a computer system 400 for implementing the picture grid tool described herein. The system 400 may include at least one processor 402 coupled to a memory 404. The processor 402 may represent one or more processors (e.g., microprocessors), and the memory 404 may represent random access memory (RAM) devices comprising a main storage of the system 400, as well as any supplemental levels of memory e.g., cache memories, non-volatile or back-up memories (e.g. programmable or flash memories), read-only memories, etc. In addition, the memory 404 may be considered to include memory storage physically located elsewhere in the system 400, e.g. any cache memory in the processor 402 as well as any storage capacity used as a virtual memory, e.g., as stored on a mass storage device 410.

The system 400 also typically receives a number of inputs and outputs for communicating information externally. For interface with a user or operator, the system 400 may include one or more user input devices 406 (e.g., a keyboard, a mouse, imaging device, etc.) and one or more output devices 408 (e.g., a Liquid Crystal Display (LCD) panel, a sound playback device (speaker, etc.).

For additional storage, the system 400 may also include one or more mass storage devices 410, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the system 400 may include an interface with one or more networks 412 (e.g., a local area network (LAN), a wide area network (WAN), a wireless network, and/or the Internet among others) to permit the communication of information with other computers coupled to the networks. It should be appreciated that the system 400 typically includes suitable analog and/or digital interfaces between the processor 402 and each of the components 404, 406,408, and 412 as is well known in the art.

The system 400 operates under the control of an operating system 414, and executes various computer software applications, components, programs, objects, modules, etc. to implement the techniques described above. Moreover, various applications, components, programs, objects, etc., collectively indicated by reference 416 in FIG. 4, may also execute on one or more processors in another computer coupled to the system 400 via a network 412, e.g. in a distributed computing environment, whereby the processing required to implement the functions of a computer program may be allocated to multiple computers over a network. The application software 416 may include a set of instructions which, when executed by the processor 402, causes the system 400 to generate the packing grid tool and associated UI's described.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others.

Although the present invention has been described with reference to specific example embodiments, it will be evident that various modifications and changes can be made to these embodiments without departing from the broader spirit of the invention.

Accordingly, the specification and drawings are to be regarded in an illustrative sense rather than in a restrictive sense.

1. A computer-implemented method, comprising:
generating a problem for a user to solve;
generating a graphical representation of a number associated with the problem; wherein the graphical representation is selected to facilitate subitizing of the number; and
overlaying visual guidance on the graphical representation to guide a user as a means to drawing attention to a learning strategy for solving the problem;
receiving and checking a user's input as a solution to the problem; and
indicating to the user a correctness of the solution.

2. The method of claim 1, wherein the graphical representation comprises a plurality of tokens, each defining a unit from which the number can be aggregated.

3. The method of claim 2, further comprising at least partially obscuring at least some of the tokens.

4. The method of claim 2, wherein the visual guidance comprising chunking groups of tokens together to form chunks for easy counting.

5. The method of claim 2, wherein the tokens are arranged in a grid to facilitate counting thereof.

6. The method of claim 4, further comprising labeling each chunk to indicate the number of items in the chunk.

7. A system, comprising:
a processor; and
a memory coupled to the processor, the memory storing instructions which when executed by the processor causes the system to perform a method for teaching math, comprising:
generating a problem for a user to solve;
generating a graphical representation of a number associated with the problem; wherein the graphical representation is selected to facilitate subitizing of the number; and
overlaying visual guidance on the graphical representation to guide a user as a means to drawing attention to a learning strategy for solving the problem;
receiving and checking a user's input as a solution to the problem; and
indicating to the user a correctness of the solution.

8. The system of claim 1, wherein the graphical representation comprises a plurality of tokens, each defining a unit from which the number can be aggregated.

9. The system of claim 8, wherein the method further comprises at least partially obscuring at least some of the tokens.

10. The system of claim 8, wherein the visual guidance comprising chunking groups of tokens together to form chunks for easy counting.

11. The system of claim 8, wherein the tokens are arranged in a grid to facilitate counting thereof.

12. The system of claim 10, wherein the method further comprises labeling each chunk to indicate the number of items in the chunk.

13. A computer-readable medium having stored thereon a sequence of instruction which when executed by a system causes the system to perform a method, comprising:
generating a problem for a user to solve;
generating a graphical representation of a number associated with the problem; wherein the graphical representation is selected to facilitate subitizing of the number; and
overlaying visual guidance on the graphical representation to guide a user as a means to drawing attention to a learning strategy for solving the problem;
receiving and checking a user's input as a solution to the problem; and
indicating to the user a correctness of the solution.

14. The computer-readable medium of claim 13, wherein the graphical representation comprises a plurality of tokens, each defining a unit from which the number can be aggregated.

15. The computer-readable medium of claim 14, wherein the method further comprises at least partially obscuring at least some of the tokens.

16. The computer-readable medium of claim 14, wherein the visual guidance comprising chunking groups of tokens together to form chunks for easy counting.

17. The computer-readable medium of claim 14, wherein the tokens are arranged in a grid to facilitate counting thereof.

18. The computer-readable medium of claim 16, wherein the method further comprises labeling each chunk to indicate the number of items in the chunk.
